(19) United States
(12) Patent Application Publication
(10) Pub. No.: US 2024/0193031 A1
(43) Pub. Date: Jun. 13, 2024

(54) TIMED-OUT CLIENT MESSAGE REPLY QUEUEING TO REDUCE BACKEND SYSTEM CALLS

(71) Applicant: INTERNATIONAL BUSINESS MACHINES CORPORATION, ARMONK, NY (US)

(72) Inventors: AMAR SHAH, Pune (IN); AJAY PONNAPPAN, BANGALORE (IN); Dominic John Storey, Eastleigh (GB); James Jose, Bangalore (IN)

(21) Appl. No.: 18/065,351

(22) Filed: Dec. 13, 2022

(51) Int. Cl. G06F 11/07

(52) U.S. Cl. CPC G06F 11/079; G06F 11/0721; G06F 11/0784

(57) ABSTRACT

An approach for reducing backend system calls. The approach determines if a client request, comprising a backend system call, has timed out. If the client request has timed out, then the approach generates a unique identity associated with the client request. The approach creates a fault message indicating a timeout of the client request. The approach inserts the unique identity into the fault message. The approach sends the fault message to the client as a response to the request. The approach creates a data structure comprising the unique identity, a timeout value, and a message buffer. The approach inserts the data structure into a message queue. Subsequently, a client sending a next request containing the unique identity can receive a response, from a slow responding backend server, after the timeout of the previous request without incurring the expense and overhead of another backend system call.

### BACKGROUND

The present disclosure relates generally to the field of client-server communications, and more particularly, to reducing backend system calls based on timed-out client message reply queueing.

An Application Server can provide a run time environment for client, e.g., a business application or an orchestrated flow, interaction and has a capability to interact with a backend System of Record (SOR) via an application communicating to the SOR with backend system calls. The application server can be exposed to the client as a Representational State Transfer (REST) or Hypertext Transfer Protocol (HTTP) endpoint for the client to consume the service.

The Application Server can pass client requests to the application for processing, and the Application can send requests to the SOR and receive replies from the SOR for return to the client. The Application Server is typically configured with a “Timeout” value for an SOR request to avoid the Application Server waiting indefinitely for a reply from the application. In general, if the application does not complete the processing of the request within the “Timeout” limit, the Application Server can send a timeout fault message to the client informing the client that the application did not respond within the “Timeout” period.

In many cases, a late reply arrives for a timed-out request and is discarded by the Application Server because the timeout fault message has already been sent to the client. Further, the client will typically retry the request, precipitating the same sequence of events that led to a timeout on the previous request. A need has evolved for preserving replies that arrive after a timeout fault message has been sent for their paired request, in anticipation of a client's retry of the failed request.

### BRIEF SUMMARY

According to an embodiment of the present invention, a computer-implemented method for reducing backend system calls, the computer-implemented method comprising: determining, by one or more processors, if a first request from a client, comprising a backend system call, has been timed out by at least one of the client or an application server; responsive to the timeout, executing actions comprising: generating, by the one or more processors, a first unique identity associated with the first request; creating, by the one or more processors, a fault message indicating a timeout of the first request; inserting, by the one or more processors, the unique identity into the fault message as a correlation identity of a response to the first request; sending, by the one or more processors, the fault message to the client as a first response to the first request; creating, by the one or more processors, a data structure comprising the unique identity, a timeout value, and a message buffer; and inserting, by the one or more processors, the data structure into a message queue.

According to an embodiment of the present invention, a computer system for reducing backend system calls, the computer system comprising: one or more computer processors and memory for executing program instructions; one or more non-transitory computer readable storage media; and program instructions stored on the one or more non-transitory computer readable storage media, the program instructions comprising: program instructions to determine if a first request from a client, comprising a backend system call, has been timed out by at least one of the client or an application server; responsive to the timeout, program instructions to execute actions comprising: program instructions to generate a first unique identity associated with the first request; program instructions to create a fault message indicating a timeout of the first request; program instructions to insert the unique identity into the fault message as a correlation identity of a response to the first request; program instructions to send the fault message to the client as a first response to the first request; program instructions to create a data structure comprising the unique identity, a timeout value, and a message buffer; and program instructions to insert the data structure into a message queue.

According to an embodiment of the present invention, a computer program product for reducing backend system calls, the computer program product comprising: one or more non-transitory computer readable storage media and program instructions stored on the one or more non-transitory computer readable storage media, the program instructions comprising: program instructions to determine if a first request from a client, comprising a backend system call, has been timed out by at least one of the client or an application server; responsive to the timeout, program instructions to execute actions comprising: program instructions to generate a first unique identity associated with the first request; program instructions to create a fault message indicating a timeout of the first request; program instructions to insert the unique identity into the fault message as a correlation identity of a response to the first request; program instructions to send the fault message to the client as a first response to the first request; program instructions to create a data structure comprising the unique identity, a timeout value, and a message buffer; and program instructions to insert the data structure into a message queue.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment and a high-level architecture, in accordance with at least one embodiment of the present invention.

FIG. 2 depicts an exemplary detailed architecture, in accordance with at least one embodiment of the present invention.

FIG. 3 depicts a flowchart of a method, in accordance with at least one embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as request timeout management component 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

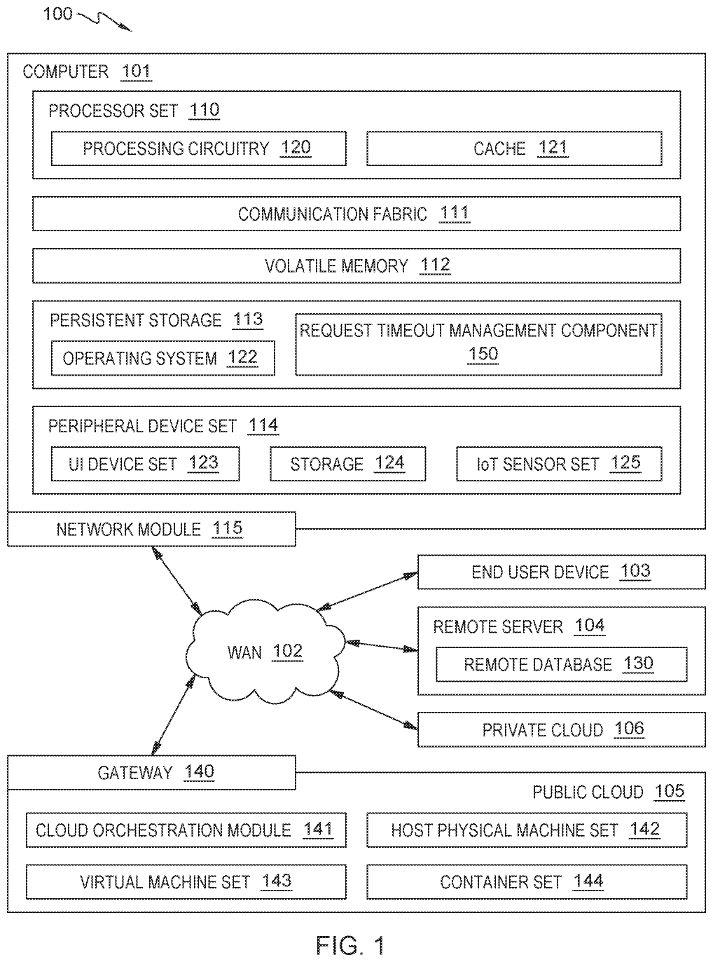

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments described herein can provide the capability for an application server to create a unique identity (ID), e.g., “responseRefID” for a timed-out request, i.e., not caching responses to successful requests that have not timed-out, only caching responses received after a client has been notified of an unsuccessful request due to a timeout. In another aspect of an embodiment of the present invention, the client can receive the “responseRefID” as part of a timeout fault message. It should be noted that a request from an application server to a backend system is timed-out by the application server and/or the client because the backend system has not sent a response to the request in a timeout period defined by the application server and/or the client.

In another aspect of an embodiment of the present invention, the application server can employ a persistent message queue to store successful responses received after a timeout fault message has been sent to the client. It should be noted that the post-timeout responses can be stored for a predetermined time interval, anticipating retry calls of the timed-out request by the client. Accordingly, the clients can receive the response for a timed-out request by sending another request, with or without a body, to the Application Server with an identifier, e.g., “responseRefID,” as part of a header wherein the Application Server can search for a response associated, e.g., matching, with the identifier in the persistent message queue, and if available, send the response to the client. It should be noted that the client can be a HyperText Transfer Protocol (HTTP) client.

It should be noted that references throughout this specification to features, advantages, or similar language herein do not imply that all the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description, and appended claims, or may be learned by the practice of the invention as set forth hereinafter.

The scope of the present invention is to be determined by the claims. Accordingly, any features, characteristics, advantages, or the like, discussed below in the discussion of embodiments of this specification shall not be taken to mean that such features, characteristics, advantages, or the like are required to practice the present invention as defined by the claims.

Embodiments of the present invention are described with reference to the Figures. It should be noted that although the example embodiments are illustrated based on backend system calls, the embodiments are applicable to any number of communication architectures.

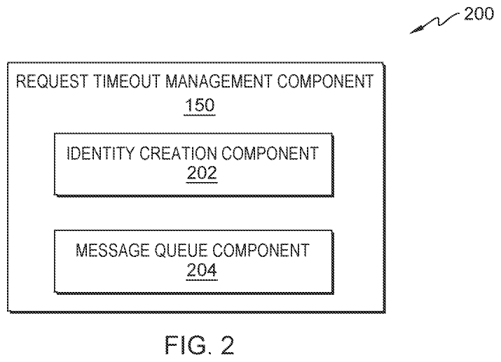

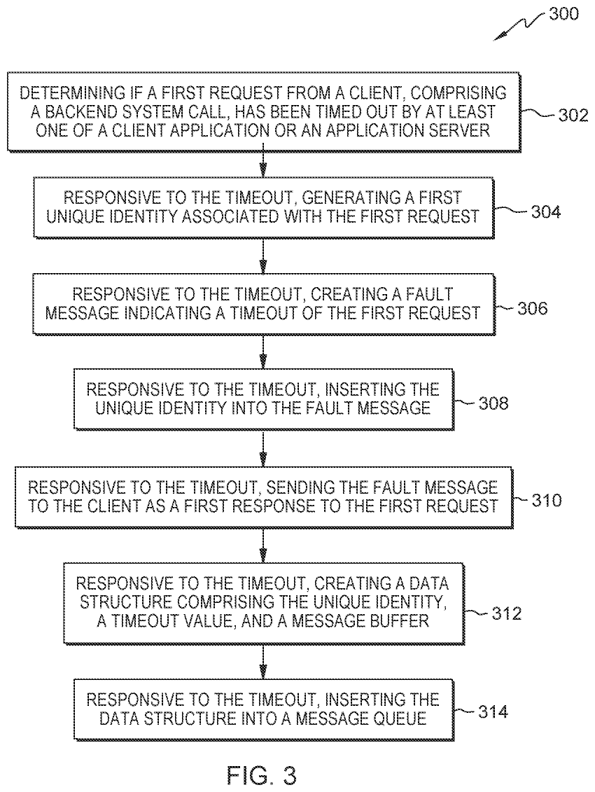

FIG. 2 is an exemplary detailed architecture for performing various operations of FIG. 3, in accordance with various embodiments. The architecture 200 may be implemented in accordance with the present invention in any of the environments depicted in FIGS. 1 and 3, among others, in various embodiments. Of course, elements other than those specifically described in FIG. 2 may be included in architecture 200, as would be understood by one of skill in the art upon reading the present descriptions.

Each of the steps of the method 300 (described in further detail below) may be performed by any suitable component of the architecture 200. A processor, e.g., processing circuit(s), chip(s), and/or module(s) implemented in hardware and/or software, and preferably having at least one hardware component, may be utilized in any device to perform one or more steps of the method 300 in the architecture 200. Illustrative processors include, but are not limited to, a central processing unit (CPU), an application specific integrated circuit (ASIC), a field programmable gate array (FPGA), etc., combinations thereof, or any other suitable computing device known in the art.

Architecture 200 provides a detailed view of at least some of the modules of computing environment 100. Architecture 200 can comprise request timeout management component 150, which can further comprise identity creation component 202, and message queue component 204.

In one aspect of an embodiment of the present invention, identity creation component 202 can provide the capability to generate a unique identity for association with a response to a client request, received after the client request has timed out. For example, identity creation component 202 can create a “responseRefID” to include in a header of a timeout response to a client request, e.g., a fault message created by request timeout management component 150, based on not receiving a response from a request to a service, e.g., a backend system call, within a predetermined timeout interval.

In another aspect of an embodiment of the present invention, identity creation component 202 can provide the capability to associate the identity with an identity extracted form a response received from a client request sent to a service after a fault message has been sent to the client based on exceeding a predetermined timeout value associated with the client request. In another aspect of an embodiment of the present invention, request timeout management component 150 can notify message queue component 204 of the creation of a fault message and the creation of a “responseRefID” for inclusion in the fault message and storage in a message queue for a predetermined amount of time.

In one aspect of an embodiment of the present invention, message queue component 204 can provide the capability to receive a “responseRefID” from request timeout management component 150 and insert the “responseRefID in a message queue along with a message buffer and a timeout value for removing the “responseRefID” from the message queue and discarding. If a response to the client request associated with the “responseRefID” is received after request timeout management component 150 has sent a fault message, then message queue component 204 can copy the response to the message buffer associated with the “responseRefID” in the message queue. It should be noted that message queue component 204 can periodically check the message queue for expired, i.e., timed out, “responseRefIDs” and, if found, message queue component 204 can remove them from the message queue along with their associated message buffer.

In another aspect of an embodiment of the present invention, if request timeout management component 150 receives a client request containing a “responseRefID” then request timeout management component 150 can provide the “responseRefID” to message queue component 204. In another aspect of an embodiment of the present invention, message queue component 204 can search through the elements of the message queue to determine if there is a match between the “responseRefID” provided in the client request and a “responseRefID” associated with an element of the message queue. If message queue component 204 can find matching “responseRefIDs” then message queue component 204 can return the response from the element message buffer to the client. It should be noted that the response returned above is the response to a previously timed out request from the client. If message queue component 204 cannot find matching “responseRefIDs” then request timeout management component 150 can initiate a new client request to the backend service. It should be noted that if message queue component 204 provides a response from the message queue to request timeout management component 150 for return to a client request, then request timeout management component 150 can set a correlation Identity (correlID) in the response header to the client to indicate to the client that the response is from a previously timed out request, not from a new request. It should be noted that the correlID can be the matching “responseRefID.” It should further be noted that if message queue component 204 cannot find a matching “responseRefID” in the message queue and the client request contains a request body, then request timeout management component 150 can initiate a new client request to the backend service.

In another aspect of embodiments of the present invention, request timeout management component 150 can improve the efficiency of the computers and networks associated with an embodiment based on reducing the load on the network for the retry request because the client can send the request without a body for retrieving the response of earlier timed out requests, and avoiding reprocessing of retry requests which may have already been successfully completed in the background after a request timeout, i.e., saving resources and expensive backend system calls and CPU cost.

FIG. 3 is an exemplary flowchart of a method 300 for reducing backend system calls. At step 302, an embodiment can determine if a request, comprising a backend system call, has been timed out by at least one of a client or an application server. If the client request, comprising the backend system call, times out, then at step 304, the embodiment can generate a first unique identity associated with the first request. At step 306, the embodiment can create a fault message indicating a timeout of the backend system call. At step 308, the embodiment can insert the unique identity into the fault message. At step 310, the embodiment can send the fault message to the client as a first response to the first request. At step 312, the embodiment can create a data structure comprising the unique identity, a timeout value, and a message buffer. At step 314, the embodiment can insert the data structure into a message queue.

What is claimed is:

1. A computer-implemented method for reducing backend system calls, the computer-implemented method comprising:
determining, by one or more processors, if a first request from a client, comprising a backend system call, has been timed out by at least one of the client or an application server;
responsive to a timeout, executing actions comprising:
generating, by the one or more processors, a first unique identity associated with the first request;
creating, by the one or more processors, a fault message indicating a timeout of the first request;
inserting, by the one or more processors, the unique identity into the fault message as a correlation identity of a response to the first request;
sending, by the one or more processors, the fault message to the client as a first response to the first request;
creating, by the one or more processors, a data structure comprising the unique identity, a timeout value, and a message buffer; and
inserting, by the one or more processors, the data structure into a message queue.

2. The computer-implemented method of claim 1, further comprising:
receiving, by the one or more processors, a first response to the backend system call associated with the first request; and
inserting, by the one or more processors, the first response into the message buffer of the data structure associated with the first request.

3. The computer-implemented method of claim 2, further comprising:
receiving, by the one or more processors, a second request from the client;
extracting, by the one or more processors, a first unique identity from the second request;
determining, by the one or more processors, if the unique identity associated with the second request matches a unique identity associated with a data structure of the message queue;
responsive to the unique identity associated with the second request matching the unique identity associated with the data structure of the message queue, sending, by the one or more processors, a message buffer associated with the data structure of the message queue to the client.

4. The computer-implemented method of claim 3, wherein the unique identity is a “responseRefID.”

5. The computer-implemented method of claim 1, wherein the client is a HyperText Transfer Protocol (HTTP) client.

6. The computer-implemented method of claim 3, further comprising:
responsive to the unique identity associated with the second request not matching the unique identity associated with the data structure of the message queue, sending, by the one or more processors, the second request to a backend system when the second request further comprises a body.

7. The computer-implemented method of claim 1, further comprising:
responsive to the unique identity associated with a second request not matching the unique identity associated with the data structure of the message queue, sending, by the one or more processors, a fault message to the client, stating the unique identity has timed out.

8. A computer system for reducing backend system calls, the computer system comprising:
one or more computer processors and memory for executing program instructions;
one or more non-transitory computer readable storage media; and
program instructions stored on the one or more non-transitory computer readable storage media, the program instructions comprising:
program instructions to determine if a first request from a client, comprising a backend system call, has been timed out by at least one of the client or an application server;
responsive to a timeout, program instructions to execute actions comprising:
program instructions to generate a first unique identity associated with the first request;
program instructions to create a fault message indicating a timeout of the first request;
program instructions to insert the unique identity into the fault message as a correlation identity of a response to the first request;
program instructions to send the fault message to the client as a first response to the first request;
program instructions to create a data structure comprising the unique identity, a timeout value, and a message buffer; and
program instructions to insert the data structure into a message queue.

9. The computer system of claim 8, further comprising:
program instructions to receive a first response to the backend system call associated with the first request; and
program instructions to insert the first response into the message buffer of the data structure associated with the first request.

10. The computer system of claim 9, further comprising:
program instructions to receive a second request from the client;
program instructions to extract a first unique identity from the second request;
program instructions to determine if the unique identity associated with the second request matches a unique identity associated with a data structure of the message queue;
responsive to the unique identity associated with the second request matching the unique identity associated with the data structure of the message queue, program instructions to send a message buffer associated with the data structure of the message queue to the client.

11. The computer system of claim 10, wherein the unique identity is a “responseRefID.”

12. The computer system of claim 8, wherein the client is a HyperText Transfer Protocol (HTTP) client.

13. The computer system of claim 10, further comprising:
responsive to the unique identity associated with the second request not matching the unique identity associated with the data structure of the message queue, program instructions to send the second request to a backend system when the second request further comprises a body.

14. The computer system of claim 8, further comprising:
responsive to the unique identity associated with a second request not matching the unique identity associated with the data structure of the message queue, program instructions to send a fault message to the client, stating the unique identity has timed out.

15. A computer program product for reducing backend system calls, the computer program product comprising:
one or more non-transitory computer readable storage media and program instructions stored on the one or more non-transitory computer readable storage media, the program instructions comprising:
program instructions to determine if a first request from a client, comprising a backend system call, has been timed out by at least one of the client or an application server;
responsive to a timeout, program instructions to execute actions comprising:
program instructions to generate a first unique identity associated with the first request;
program instructions to create a fault message indicating a timeout of the first request;
program instructions to insert the unique identity into the fault message as a correlation identity of a response to the first request;
program instructions to send the fault message to the client as a first response to the first request;
program instructions to create a data structure comprising the unique identity, a timeout value, and a message buffer; and
program instructions to insert the data structure into a message queue.

16. The computer program product of claim 15, further comprising:
program instructions to receive a first response to the backend system call associated with the first request; and
program instructions to insert the first response into the message buffer of the data structure associated with the first request.

17. The computer program product of claim 16, further comprising:
program instructions to receive a second request from the client;
program instructions to extract a first unique identity from the second request;
program instructions to determine if the unique identity associated with the second request matches a unique identity associated with a data structure of the message queue;
responsive to the unique identity associated with the second request matching the unique identity associated with the data structure of the message queue, program instructions to send a message buffer associated with the data structure of the message queue to the client.

18. The computer program product of claim 17, wherein the unique identity is a “responseRefID” and the client is a HyperText Transfer Protocol (HTTP) client.

19. The computer program product of claim 17, further comprising:
responsive to the unique identity associated with the second request not matching the unique identity associated with the data structure of the message queue, program instructions to send the second request to a backend system when the second request further comprises a body.

20. The computer program product of claim 15, further comprising:
responsive to the unique identity associated with a second request not matching the unique identity associated with the data structure of the message queue, program instructions to send a fault message to the client stating the unique identity has timed out.
